(19) United States
(12) Patent Application Publication
(10) Pub. No.: US 2009/0288483 A1
(43) Pub. Date: Nov. 26, 2009

(54) Water level & temperature indicator

(76) Inventors: Jeffrey Alfred Varga, Greensboro, NC (US); Joan Marie Varga, Greensboro, NC (US)

Correspondence Address: Jeffrey A. Varga, 5508 Wellsley Dr. E., Greensboro, NC, 27407, US

(21) Appl. No.: 12/313,122

(22) Filed: Nov. 18, 2008

Related U.S. Application Data
(60) Provisional application No. 61/055,825, filed on May 23, 2008.

(51) Int. Cl. G01F 23/00; G01F 23/30

(52) U.S. Cl. 73/292; 73/313

(57) ABSTRACT

A water level and temperature indicating device useful for signaling preset desired water levels in a bath tub and indicating air and bathwater temperature. The device has suction cup means for removably securing the device to the tub ledge. A depending float chamber and temperature probe for projecting into the bathtub, a battery operated audible alarm system and a battery operated digital thermometer device. An interchangeable weighted float of various lengths is housed within a float chamber. The float chamber has a removable screen unit to facilitate float changes which determine desired preset water level. A modified push on switch within the float chamber will complete an electrical circuit and sound an alarm when a desired preset water level is achieved. The thermometer device will indicate air temperature until it makes contact with the water. While in contact with water the thermometer device indicates water temperature.

I claim benefit of provisional application 61/055,825 filed on May 23, 2008

### DETAILED DESCRIPTION OF THE INVENTION

Referring now to the views of the drawing, it will be noted that the water level and temperature indicating device 1 comprises a hood unit 3 carrying a laterally extended cylindrical tube member 2 at one end. Both units are primarily made of a suitable metal or plastic material and are connected together by suitable fasteners 4 or a spot weld 4.

Member 2 is hollow and is open at the bottom end with the exception of a removable screen unit 5 which is press fitted into the member 2. The screen unit is comprised of a screen of suitable material imbedded in a flexible plastic or rubber casting. A rubber bumper 6 is fixed to the lower side of member 2 with double sided tape or other suitable adhesive. Member 2 contains a cylindrically shaped float unit 7 which is primarily made from Styrofoam or cork. This float contains a small weight 8 made of stainless steel or suitable material. Member 2 also contains a modified, push on switch 9. This switch 9 is mounted inside the upper portion of member 2 using a press fitted rubber seal 10. The modification of the switch 9 includes the removal of the push button release spring of a push on switch. This modification allows the switch button 11 to be depressed with very little pressure, thus allowing a much smaller than usually required float unit 7 to fully depress the switch. The switch button 11 returns to its open position by the force of gravity and the weight of the switch button 11 itself, when pressure from the float unit 7 is released. The switch 9 is connected by insulated wires to an electrical circuit FIG. 4 comprised of a detachable battery 12, push on/off switch 13, audible alarm device 14, modified push on switch 9 and suitable gauge of insulated wire 27.

At the end of the hood unit 3, opposite member 2 is a push on/off switch 13 mounted through a hole of desired proportion. This switch 13 is to open or close the audible alarm device 14 electrical circuit FIG. 4 and will as a result enable or disable the water level indication portion of this invention.

The open bottom side of the hood unit 3 is fitted with a plastic cover plate 15. This cover plate 15 is inserted into the bottom of the hood unit 3 by a press fit. Attached to the cover plate is a suction cup 16 and the audible alarm device 14. The suction cup 16 is attached to the cover plate 15 by press fit into a hole in the plate 15 of desired proportion. The audible alarm device 14 is mounted through a hole in the plate 15 of desired proportion and is secured by a suitable fastener.

A stainless steel temperature probe 17 runs parallel to member 2 and is fixed to member 2 with a suitable fastener. The probe 17 is covered in rubber heat shrink tubing 18 with the exception of the bottom end which is exposed for quick accurate response to temperature variation. The probe 17 is connected by two wires to a battery 19 operated digital thermometer device 20 that is mounted inside the hood unit 3 at an opening at the top of the hood unit 3. This digital thermometer device 20 is secured to the hood 3 by epoxy, silicone or hot glue. The said thermometer device 20 has a LCD readout 21 that indicates temperature values in Celsius or Fahrenheit degrees. On/off 22 and Fahrenheit/Celsius 23 selection buttons on this thermometer device 20 have control of the thermometer device 20 only.

In operation the device 1 as shown in FIG. 3 is removably attached to the top ledge 25 of a bathtub by the included suction cup 16 with member 2 and the thermometer probe 17 depending into the tub. A rubber bumper 6 located on the bottom side of member 2 bears member 2 against the tub wall 26. As the tub is filled, the water level rises and enters the bottom end of member 2 through the screen 5. As the water rises it raises the float 7 and displaces air in member 2. The displaced air simultaneously escapes through the orifice 24 of member 2. Continued filling of the tub will cause the float 7 to rise in member 2 ultimately reaching switch 9 level. As the float 7 applies pressure to the switch button 11, it raises up the switch button 11 which closes the electrical circuit FIG. 4 of the water level indicating portion of the invention and sounds an alarm 14. This indicates that the preset desired water level is achieved. The alarm 14 will sound until either the on/off switch 13 is depressed, disabling the alarm circuit FIG. 4 or the water level is lowered causing the float 7 level to drop thus relieving switch button 11 pressure and opening the alarm circuit FIG. 4. The float 7 is weighted with a stainless steel weight 8 in order to assist it's descent to the bottom of member 2 when water level in member 2 recedes. The weighting of the float 7 also allows closer float 7 clearances in member 2 which minimizes the necessary member 2 inside diameter. The weighted float 7 also assists the descent of the float when member 2 is not completely vertical. Using different lengths of floats 7 will dictate the water level necessary to sound the alarm thus the float 7 is interchangeable to incorporate a variety of float 7 lengths. Removal of the screen 5 of member 2 allows necessary float 7 changes to achieve the desired preset water level. The thermometer probe 17 indicates air temperature while not in contact with the water and provides water temperature when it contacts the water.

While I have illustrated and described the preferred embodiments of my invention, it is to be understood that I do not limit myself to the precise constructions shown herein disclosed and the right is reserved to all changes and modifications coming within the scope of the invention as defined in the appended claims. It should be understood that indicator 1 may be used in other places, such as a kitchen sink, laundry sink, hot tub, pool, or pond. Indicator 1 may be used in completely diverse areas such as a sump pit, reservoir or even the bilge of a boat and be used for liquids other than water. Indicator 1 may also include the use of a transmitter in the alarm electrical circuit to send a signal to a receiver which will energize a servo to close a water supply valve for the bathtub. This transmitter may also activate a mobile audible alarm device such as a pager. It is intended that all matter contained in the foregoing description and shown in the accompanying drawings shall be determined as illustrative only. It is to be understood that features of the digital thermometer 20 are limited to the brand or model of thermometer device used in the construction of the embodiments of my invention.

### BACKGROUND OF THE INVENTION

This invention relates to a signal alarm for use to audibly indicate desired preset water level when filling a bathtub with water and monitoring water or air temperature. The device is removably attached to the bathtub ledge with a suction cup. When filling a tub with water one will some times be distracted and forget about the water flowing. This can be disastrous especially when the bathtub is on an upper floor in the building. Most bathtubs have overflows but in most cases the overflows have limited capabilities. Usually these overflows can't disperse the amount of water supplied by the faucet quick enough to prevent overflow. It is also wasteful to have the water flowing longer than needed not only for the waste of water but also for the wasted energy to heat the water.

It is, therefore, an object of this invention to sound an alarm when the water in a bathtub being filled, has reached it's desired preset level thus preventing overflow and waste. Another object of this invention is to sound an alarm in the case of a tub filling with sewage due to sewer backup.

The probe type digital thermometer portion of this invention is a great aid in safety and health. Many medical circumstances call for specific water temperature when bathing. Infants, small children and pets should not exceed specific water temperatures while bathing.

It is, therefore, an objective of this invention to provide accurate indication of liquid and air temperature for reasons of health and safety of both people and animals.

### BRIEF SUMMARY OF THE INVENTION

This water level and temperature indicating device is much more desirable both aesthetically and functionally than any previous invention of similar scope. With it's bathtub ledge mounting and it's slender float chamber, this device is much less invasive to the bathtub than other previous devices. A smaller diameter float chamber than normally required is achieved by incorporating a weighted float. A weighted float is used to aid float descent within the float chamber and it also facilitates much closer float to inner float chamber clearances. The use of a modified push on switch in the float chamber requires very little float pressure to close the alarm electrical circuit thus allowing the use of a smaller than normally required float. Using floats of different lengths will determine the water level necessary to raise the float within the float chamber to sound the alarm. A long float will require a lower water level to sound the alarm than a short float. The use of a removable screen unit at the bottom of the float chamber allows quick and easy float change. Removal of the screen unit also facilitates the cleaning of the inner float chamber. The inclusion of a probe type digital thermometer device dramatically broadens the scope of this invention in comparison with previous inventions of similar scope and provides significant health and safety advantages.

### BRIEF DESCRIPTION OF DRAWINGS

FIG. 1 is a perspective view of my water level and temperature indicator which shows the float, switch, battery, suction cup, audible alarm device, bottom cover plate and the electrical wires in phantom lines.

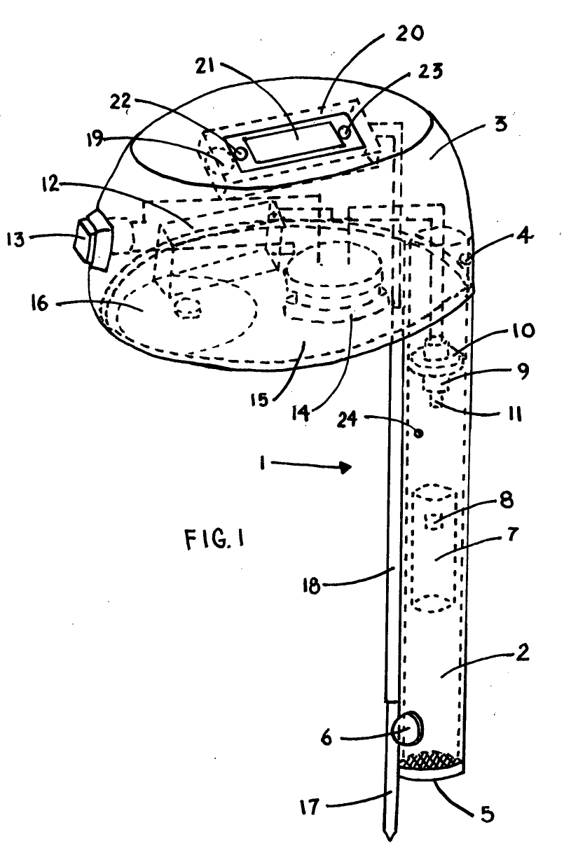

FIG. 2 is a perspective view of my water level and temperature indicator.

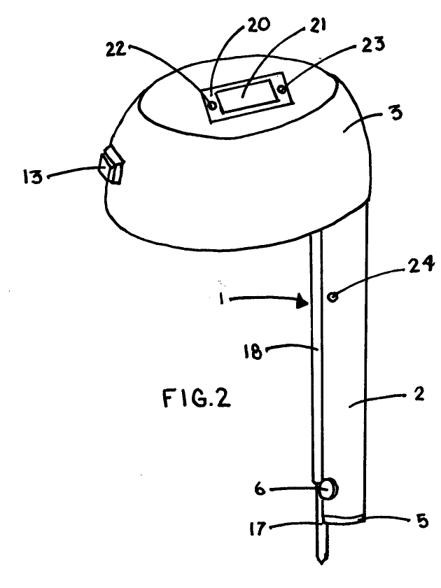

FIG. 3 is a plain elevation side view taken from the side of the preferred embodiment mounted on a bathtub ledge.

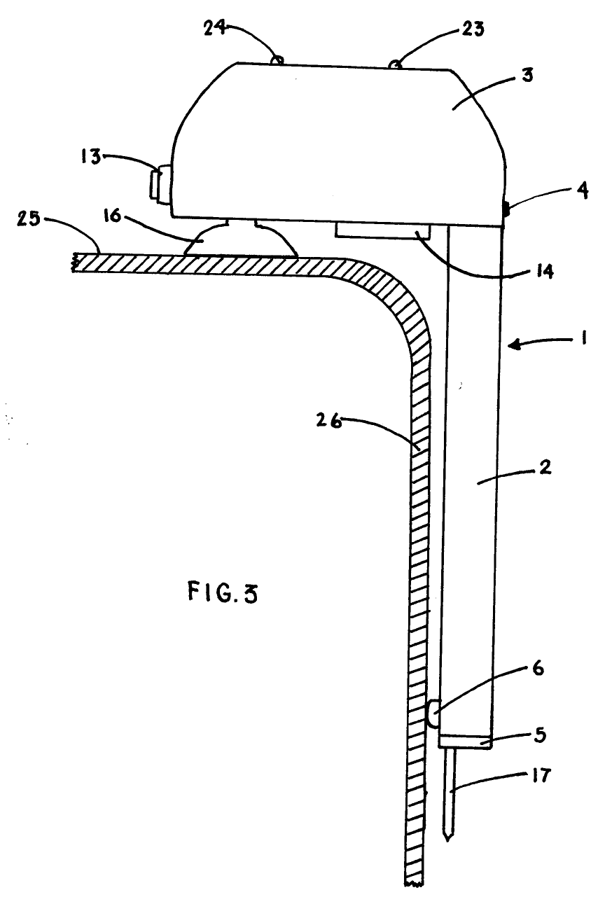

FIG. 4 is a schematic of the electrical circuit related to the water level indicator portion of the invention

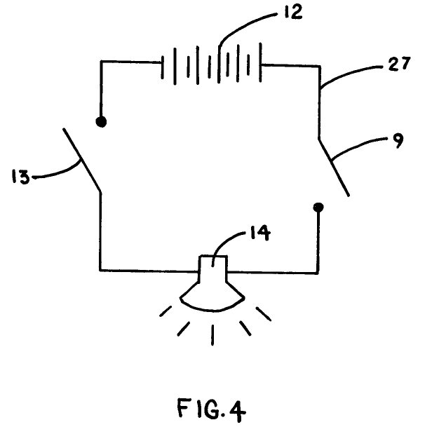

Having thus described my invention with the foregoing description and drawings, what I claim as new, and desire to secure by United States Letters Patent is:

1. A water level and temperature indicating device useful in a bathtub or the like comprising of a member carrying the means to fasten the indicator to the tub ledge, an elongated float chamber depending from the member, a removable screen at the bottom end of the float chamber, a rubber bumper fixed near the bottom of the side of the float chamber, an orifice on the upper side of the float chamber just below switch level, a temperature probe depending from the member parallel to the float chamber, a digital thermometer devise with LCD readout and a battery and function controls, a weighted float within the float chamber, a push on/gravity off switch mounted with a rubber seal within the upper portion of the float chamber, a push on/off switch, an electrical circuit interconnecting the alarm device and battery and being provided with two switches and a receptacle, so that when the tub is filled with liquid the float will rise within the said float chamber and when the float reaches the switch, it depresses the switch button thus closing the electrical circuit of the water level indicator portion of the said device, the digital thermometer portion of the said device will display air temperature values until it makes contact with liquid.

2. The indicator of claim 1, wherein said device is mounted on the tub ledge with suction cup.

3. The indicator of claim 1, wherein said device bears on a rubber bumper against the tub wall.

4. The indicator of claim 3, wherein said rubber bumper is adhered to the lower side of the float chamber.

5. The indicator of claim 1, wherein said float is weighted with small weight of desired proportion and desired material.

6. The indicator of claim 5, wherein said float is interchangeable with floats of different lengths for adjustability of desired preset water levels.

7. The indicator of claim 1, wherein said float chamber is fitted with a removable screen unit.

8. The indicator of claim 7, wherein said screen unit is installed and removed by press fit, allowing float change and cleaning.

9. The indicator of claim 1, wherein said modified push on switch is mounted in the upper section of the float chamber.

10. The indicator of claim 9, wherein said switch modification includes the removal of the switch button release spring.

11. The indicator of claim 1, wherein said inclusion of a digital thermometer device with LCD display comprising of a battery operated digital thermometer devise, insulated wires and a permanently fixed temperature probe.
